(19) United States
(12) Patent Application Publication
(10) Pub. No.: US 2023/0134903 A1
(43) Pub. Date: May 4, 2023

(54) BENDING MACHINE

(71) Applicant: SCHWARZE-ROBITEC GMBH, (US)

(72) Inventor: Hubert ZORN, Köln (DE)

(73) Assignee: SCHWARZE-ROBITEC GMBH, Köln (DE)

(21) Appl. No.: 17/911,351

(22) PCT Filed: Mar. 10, 2021
(86) PCT No.: PCT/EP2021/056061

§ 371 Date: Sep. 13, 2022

(30) Foreign Application Priority Data
Mar. 23, 2020 (DE) 10 2020 107 919.2

(51) Int. Cl. B21D 7/024

(52) U.S. Cl. CPC B21D 7/024

(57) ABSTRACT

A bending machine for bending profiles having a bending tool with a bending axis. The bending tool has at least one bending template forming a bending radius, and a swing arm that is pivotable about the bending axis. The swing arm has at least one clamping jaw which cooperates with the at least one bending template to fix a profile to be bent, having a profile separating device which is arranged on a tool holder and has a tool head. The tool head has a separating device and a cutout forming a separating region, the cutout extending as far as an edge of the tool head and forming an opening. The profile separating apparatus and the profile to be separated are movable relative to one another in a radial direction of the profile. The profile is insertable through the opening into the cutout and into the separating region.

The present invention relates to a bending machine for bending elongated profiles, in particular round tubes.

Previously known bending machines, for example such as those that have become known from DE 20 2014 104 329 U1 of the applicant, have a bending tool with a bending axis, wherein the bending tool has at least one bending template forming a bending radius and a swing arm that is pivotable about the bending axis. The swing arm has a clamping jaw which cooperates with the at least one bending template in order to fix a round tube to be bent.

During the bending process, the swing arm is pivoted about the bending axis, wherein the clamping jaw bends the round tube according to the bending radius of the bending template.

In such bending machines, the round tubes are formed in a cold forming process.

Usually, the round tubes to be bent are twistable in the bending machine so that the round tube to be bent can be formed in different directions.

The formed round tube can thus have a relatively complicated shape produced by means of several bending operations. Particularly in the case of the previously known bending machines, very long round tubes are very often used, from which a plurality of identical bent tube sections are to be produced, so that these have to be separated from the remaining tube that has not yet been bent after the bending process.

The tube is usually separated at a point upstream of the bending tool so that the finished bent tube sections still have straight, unbent sections at one end that were necessary to hold the tube during the bending process. However, such straight tube sections are not desired in many end products made from the round tube so that they have to be separated from the tube to be produced in a further work step. In addition to the further work step, the straight tube sections to be separated also produce scrap material, which increases the costs for producing the bent round tubes.

Therefore, it is an object of the present invention to provide a bending machine which makes is possible to separate the bent tubes or profiles with reduced material scrap.

The bending machine according to the invention is defined by the features of claim 1.

The bending machine according to the invention for bending elongated profiles, in particular round tubes, has a bending tool with a bending axis, wherein the bending tool has at least one bending template forming a bending radius. Furthermore, the bending machine has a swing arm pivotable about the bending axis, wherein the swing arm has at least one clamping jaw which cooperates with the at least one bending template in order to fix a profile to be bent.

The bending machine according to the invention is characterized by a profile separating device which is arranged on a tool holder and has a tool head, wherein the tool head has a separating apparatus and a cutout forming a separating region, said cutout extending as far as an edge of the tool head and forming an opening, wherein the profile separating device and the profile to be separated are movable relative to one another in a radial direction of the profile, wherein the profile is insertable through the opening into the cutout and into the separating region.

By providing the profile separating device with a tool head having a cutout into which the profile can be inserted by means of a relative movement between the tool head and the profile in the radial direction of the profile, the tool head can engage the profile at any point. In the case of profiles that have already been bent, there is often a difficulty in separating them due to the bent shape. However, in the bending machine according to the invention, the separating apparatus can also be applied to profiles that have already been bent, since the separating apparatus can be applied to the profile in the radial direction of the profile. In the bending machine according to the invention, either the separating apparatus is moved to the profile to be separated or the profile to be separated is advanced to the separating apparatus and moved into the cutout. Of course, a combination of these two variations of movement is also possible.

The bending machine according to the invention thus makes it possible in an advantageous manner that almost any bent shape of a profile can be separated at a desired point so that almost no or only little material scrap is produced with the separated bent profile sections.

The bending machine according to the invention can be used to bend different elongated profiles such as tubes, round tube, oval tubes, or other non-hollow profiles.

Preferably, the separating region of the separating apparatus has a separating axis, wherein the profile to be separated is arranged coaxially to the separating axis during the separation process. Meanwhile, the cutout extends in a radial direction of the tool head towards the edge of the tool head so that a radial opening is formed.

Preferably, it is provided that the tool head of the profile separating device is movable by means of the tool holder in the direction of the profile to be separated. Here, it may be provided that the tool holder drives the tool head rotationally about at least one axis, whereby the position of the separating axis can be changed.

Preferably, the tool holder is designed as a robotic arm. In this manner, the tool head can be advantageously moved in the direction of the profile and placed thereon. When designing the tool holder as a robotic arm, it is particularly possible for the tool head to be moved adjustably in several axes so that the tool head can be applied to at almost any point on the profile to be separated.

The bending machine according to the invention may also have a profile guiding device which feeds the profile to the bending tool in the horizontal direction, wherein the profile is movable in the vertical direction by the profile guiding device. Thus, the profile guiding device can be used to move the profile to be separated towards the profile separating device. For example, the profile guiding device can also be used to move the profile in the vertical direction in order to bend the profile at another bending template in a bending tool with several bending templates arranged one above the other.

Thus, the bending machine according to the invention can be designed in a structurally simple manner, since the profile guiding device provided, for example, in a multi-groove bending machine for moving the profile in the vertical direction can also be used for feeding the bent profile to the separating apparatus.

In general, the bending machine according to the invention may also have a profile guiding device which feeds the profile to the bending tool only in the horizontal direction, wherein the bending tool is movable in the vertical direction in order to align the profile and the corresponding bending template to each another. Here, the profile separating device may be connected to the bending tool via the tool holder so that the profile separating device is movable with the bending tool in the vertical direction. Thus, the profile separating device can be moved relative to the profile.

It may be provided that the tool holder is arranged on the swing arm. This makes it possible to apply the tool head at different points on the bent profile or to arrange the tool head at the correct angle, respectively so that the profile to be separated can be introduced into the cutout in the radial direction.

It may also be provided that the tool holder has a bearing device which rotationally mounts and/or displaceably mounts the tool head in the horizontal direction. In this manner, the tool head is alignable in a particularly advantageous manner with respect to the profile to be separated.

Preferably, it is provided that the separating apparatus has a cutting tool or a removing tool. A cutting tool can be used to perform a method step of cutting (DIN 8588) for the separation of the profile so that a cutting operation takes place without chip removal. This enables very precise production of the desired bent profile, while at the same time keeping material scrap to a minimum.

A removing tool can be used to perform a method step of removal (DIN 8590) in which a non-mechanical separation takes places, which also results in no or only little material scrap. For example, a laser cutting device can be used as a removing tool.

In the exemplary embodiment of the bending machine according to the invention, in which the separating apparatus has a cutting tool, it may be provided that the cutting tool is an orbital cutting device. An orbital cutting device, in which a knife is guided around the profile for the cutting process, separating the profile can be carried out in a particularly advantageous manner. Such orbital cutting devices can be used to separate tubes, in particular round tubes, in an advantageous manner.

Here, it may be provided that the orbital cutting device has at least one cutting knife wheel arranged on a knife carrier, which can be guided around the profile to be separated during the cutting process and can be delivered in the radial direction of the profile to be separated. In this manner, the profile can be separated in a particularly advantageous manner.

It may be provided that the delivery of the at least one cutting knife wheel is effected by a controller. Thus, it is automatically delivered so that the cutting process can be fully automatic.

In the orbital cutting device according to the invention, it may be provided that a cutting tool carrier disk is arranged in the tool head, wherein the cutting tool carrier disk has a second cutout which is aligned with the cutout of the head tool in a basic position. The at least one knife carrier together with the cutting knife wheel is arranged in the cutting tool carrier disk. After the profile has been introduced into the cutout and the second cutout, the cutting tool carrier disk is rotationally driven and the cutting knife wheel is delivered in the radial direction of the profile to be separated. This allows the desired separation process to be configured in a simple manner.

Preferably, it is provided that the bending machine has a profile sliding device on which the profile abuts during the bending process, wherein the profile sliding device is arranged upstream of the bending tool in longitudinal direction of the profile. The profile sliding device can guide the profile in the axial direction during the bending process and, for example, can also be moved in the axial direction. In combination with the profile sliding device, a crease smoothing device may also be arranged which cooperates with the profile sliding device.

The profile sliding device may be arranged between the profile guiding device and the bending tool.

In the bending machine according to the invention, it may also be provided that the tool head engages the profile in the feeding direction of the profile downstream of the bending tool, between the profile sliding device and the bending tool, or upstream of the profile sliding device. Depending on the configuration of the profile to be bent, one of these positions can be advantageous for separating the profile.

In the following, the invention is described in more detail with reference to the single figure.

The FIGURE schematically shows a bending machine 1 for bending round tubes 100, for example.

The bending machine 1 shown in the FIGURE is a so-called multi-groove bending machine. The bending machine 1 has a bending tool 3 forming a bending axis 5. The bending tool 3 has several bending templates 7 forming a bending radius, said bending templates 7 being arranged one above the other. In addition, a swing arm 9 pivotable about the bending axis 5 is provided on which the clamping jaws 11 are arranged which cooperate with the bending templates 7 in order to fix the round tube 100 to be bent.

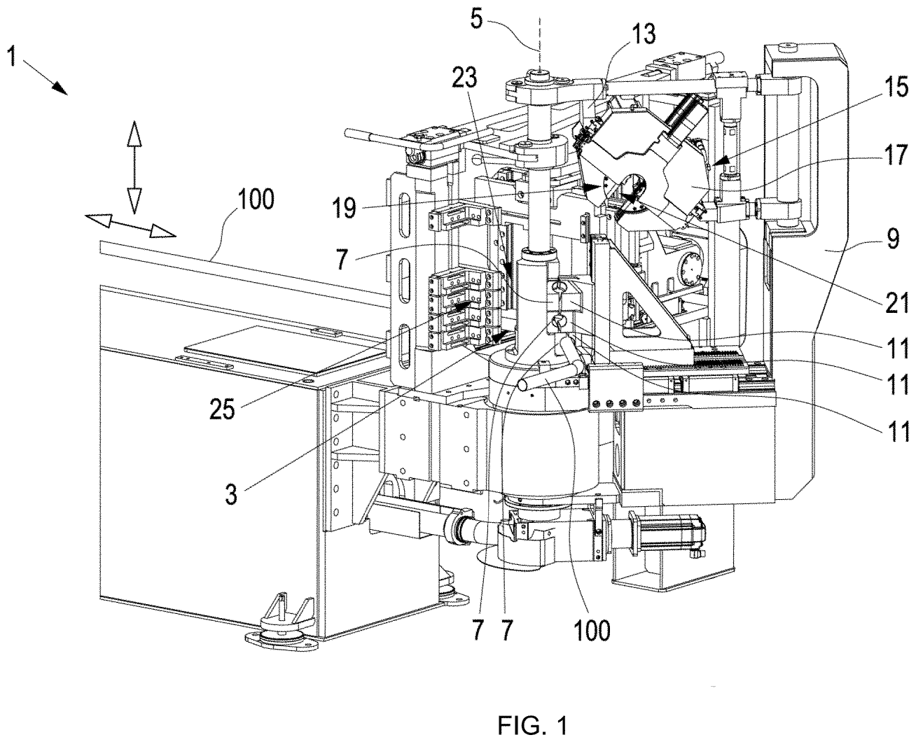

A profile separating device 15 is arranged on a tool holder 13, the profile separating device 15 comprising a tool head 17 having a separating apparatus 19. In the exemplary embodiment illustrated in FIG. 1, the profile separating device 15 is arranged on the swing arm 9 and is thus pivotable by means of the swing arm 9.

The separating apparatus 19 has a cutout 21 forming a separating region, said cutout 21 extending as far as an edge of the tool head 17. Thus, an opening is formed through which the round tube 100 to be separated can be introduced in the radial direction of the round tube 100 and also in the radial direction of the tool head 17.

The bending machine according to the invention has a profile guiding device, which is not illustrated, by means of which the round tube 100 is movable in the vertical and horizontal direction such as indicated by the double arrow. In this manner, the round tube 100 can, on the one hand, be arranged in the corresponding bending template 7 and, on the other hand, can also be introduced into the cutout 21 of the tool head 17 of the profile cutting device 15 by means of a vertical movement. In the exemplary embodiment shown in the FIGURE, the separating apparatus 19 is configured as an orbital cutting device and has knife carriers, which are not illustrated, with cutting knife wheels arranged thereon which are guided around the round tube 100 to be separated during the cutting process and can be delivered in the radial direction of the round tube to be separated. In this manner, chipless separation of the round tube 100 can be effected.

In general, the tool holder 13 can be configured to have a bearing device by means of which the tool head 17 is rotationally mounted and/or displaceable in the horizontal direction.

The swing arm 9 and, if necessary, the tool holder 13 can be used to align the tool head 17 with respect to the round tube 100 so that when the round tube 100 is introduced into the cutout 21 and thus into the separating region, separation is possible at the desired position of the round tube 100.

In the exemplary embodiment shown in the FIGURE, the profile separating device 15 engages the round tub 100 in the tube direction downstream of the bending template 7 and performs the separating cut there. However, in general, the tool head 17 can also be arranged at a different point on the round tube 100.

For example, the bending machine 1 may have a profile sliding device 23 arranged upstream of the bending tool 3 in the longitudinal direction of the tube, with a crease smoothing device 25 cooperating therewith, and the tool head 17 may engage between the profile sliding device 23 and the bending tool 3.

The bending machine 1 according to the invention and the profile separating device 15 arranged thereon can be used to produce bent tube sections of a round tube 100 in a particularly advantageous manner, wherein there is only little or no material scrap. This enables particularly economical production of the tube sections. The configuration of the bending machine 1 according to the invention shown in the FIGURE has the particular advantage that an already present profile guiding device is used for vertically feeding the round tube 100 to be separated to the profile separating device 15.

Of course, it is also possible for the tool head 17 to be moved by means of the tool holder 13 in the direction of the round tube 100 to be separated, for example by designing the tool holder 13 as a robotic arm.

### LIST OF REFERENCE NUMERALS

1 bending machine

3 bending tool

5 bending axis

7 bending template

9 swing arm

11 clamping jaw

13 tool holder

15 profile separating device

17 tool head

19 separating apparatus

21 cutout

23 profile sliding device

25 crease smoothing device

100 round tube

1-13. (canceled)

14. A bending machine for bending profiles having a bending tool with a bending axis, wherein the bending tool has at least one bending template forming a bending radius, and having a swing arm pivotable about the bending axis, wherein the swing arm has at least one clamping jaw which cooperates with the at least one bending template in order to fix a profile to be bent,
and
a profile separating device which is arranged on a tool holder and has a tool head, wherein the tool head has a separating apparatus and a cutout forming a separating region, said cutout extending as far as an edge of the tool head and forming an opening, wherein the profile separating device and the profile to be separated are movable relative to one another in a radial direction of the profile, wherein the profile is insertable through the opening into the cutout and into the separating region.

15. The bending machine according to claim 14, wherein the tool head of the profile separating device is movable by means of the tool holder towards the profile to be separated.

16. The bending machine according to claim 15, wherein the tool holder is designed as a robotic arm.

17. The bending machine according to claim 14, further comprising a profile guiding device which feeds the profile to the bending tool, wherein the profile is movable in the vertical direction by the profile guiding device.

18. The bending machine according to claim 14, wherein the tool holder is arranged on the swing arm.

19. The bending machine according to claim 18, wherein the tool holder has a bearing device which rotationally mounts and/or displaceably mounts the tool head in the horizontal direction.

20. The bending machine according to claim 14, wherein the separating apparatus has a cutting tool or a removing tool.

21. The bending machine according to claim 20, wherein the removing tool is a laser cutting device.

22. The bending machine according to claim 20, wherein the cutting tool is an orbital cutting device.

23. The bending machine according to claim 22, wherein the orbital cutting device has at least one cutting knife wheel arranged on a knife carrier, which can be guided around the profile to be separated during the cutting process and can be delivered in the radial direction of the profile to be separated.

24. The bending machine according to claim 10, wherein the delivery of the at least one cutting knife wheel is effected by a controller.

25. The bending machine according to claim 14, wherein a profile sliding device on which the profile abuts during the bending process, wherein the profile sliding device is arranged upstream of the bending tool in the longitudinal direction of the profile.

26. The bending machine according to claim 14, wherein the tool head engages the profile in the feeding direction of the profile downstream of the bending tool, between the profile sliding device and the bending tool, or upstream of the profile sliding device.
